(19) United States
(12) Patent Application Publication
(10) Pub. No.: US 2004/0040171 A1
(43) Pub. Date: Mar. 4, 2004

(54) Dryer for printing machine

(76) Inventor: Reinhardt Listmann, Lauterbach (DE)

Correspondence Address: Adams Evans P.A., 2180 Two Wachovia Center, Charlotte, NC, 28282, US

(21) Appl. No.: 10/457,676

(22) Filed: Jun. 9, 2003

(30) Foreign Application Priority Data
Jun. 10, 2002 (DE) 102 25 753.1

(51) Int. Cl. F26B 19/00

(52) U.S. Cl. 34/229

(57) ABSTRACT

A dryer adapted for use with a printing machine, and having at least one nozzle arrangement (6) with elongated, linearly effective nozzle output (7), especially wide slot nozzle arrangement, to blow a drying medium, especially air, onto a surface (16) to be dried, characterized in that the nozzle arrangement (6) has an effective nozzle opening width of 0.01 mm to 0.5 mm.

### TECHNICAL FIELD AND BACKGROUND OF THE INVENTION

This invention relates to a dryer, especially for a printing machine. Dryers of the type described are used in particular, but not at all exclusively, for the drying of printing substrate webs and/or sheets during rotary printing. For example, in multi-color flexography, such as corrugated board direct printing, it is necessary to dry the printing substrate web and/or the corrugated board sheets after they pass the inking station as well as when they leave the printing machine so as to avoid a soiling of the respective subsequent printing stations, to obtain the desired high through-put speeds through the printing press, and to simplify and speed up the handling of the finished printed webs and/or the finished printed sheets.

Often, for example with the multi-color flexography on corrugated board, environmentally safe water-based printing colors are now being used, which, however, require especially high-performance intermediate-and end dryers in the printing press owing to the low evaporation tendency of water. Because of the cramped spatial conditions in the printing press, especially between the individual inking stations, a relatively high volume flow of a drying medium with an optimally high flow speed must be blown onto the—usually small—available drying surface of the printing substrate web to dry the printing substrate web.

It is known to use dryers for this purpose having nozzle arrangements with an elongated linearly effective nozzle output, so that the volume flow to be blown onto the printing substrate web is essentially blown onto the web transversely to the direction of movement of the web as well as across the entire width of said web. The nozzle arrangement used in the sate of the art is generally one or a plurality of wide slot nozzles that are arranged in tandem and/or side-by-side, and in the generic drying means, heated is usually used as the drying medium that takes up the solvent and/or the water vapor from the wet printing ink.

Because the printing substrate web and the printing ink on said printing substrate web, which is still wet, is guided through the printing machine and past the drying means at a high speed of up to several meters per second, a very intensive load of the drying medium flowing out of the wide slot nozzle and onto the wet surface of the web is required to obtain a sufficient drying effect in the short time, i.e., only a fraction of seconds, available for the drying.

In accordance with the state of the art, the desired high drying performance is supposed to be obtained by blowing an optimally high hot air flow onto the narrow strip of the continuous printing substrate web available for drying.

However, generating an optimum volume flow of hot air for one requires a high energy effort, due to the required performance of the fans as well as with respect to the heating performance required to heat the air. In addition, the supply of the high volume flow to the printing press, and at the printing press into the area of the dryer means and/or the nozzle arrangement, requires large-volume supply lines. However, the installation of these high-volume supply lines for the drying air leads to cramped space conditions, especially with the increasingly more compactly designed modern printing presses, and thus to difficulties in the construction, production, operation and maintenance of the printing press. In addition, it goes without saying that the high quantities of hot air that is supplied also have to be discharged away from the web and out of the printing press, which requires additional large-volume air ducts.

Finally, the drying effect of the drying medium blown onto the web also reaches its limit when it is no longer possible for a large part of the volume flow to reach an effect inside the boundary layer area at the web surface, which is the decisive factor for the transfer of the humidity into the drying medium.

In other words, this means that given the small drying surface, which usually only has the form of a small strip, any further increase in the volume flow can practically no longer lead to a further improvement of acceleration of the drying process from a specific air-throughput on. In the high throughput speeds related to the modern printing processes, the generic drying means known from the state of the art therefore increasingly reach technological and/or thermodynamic limits.

Given this background, the present invention is based on the problem of finding a dryer to overcome the aforementioned disadvantages and limits, which has a significantly increased drying effect and at the same time clearly reduced energy consumption as well as a lower space requirement, especially in the immediate area of the printing machine itself.

### SUMMARY OF THE INVENTION

Therefore, it is an object of the invention to provide a dryer in accordance with the present invention that has at least one generally known nozzle arrangement, having a nozzle output along an elongated line so as to enable the line-shaped loading of a continuous printing substrate web and/or printing substrate sheets transversely to the direction of transport. This may be especially, but not at all exclusively, a wide slot nozzle arrangement through which a drying medium, especially air, is blown onto the surface to be dried to take up solvent vapor.

In accordance with the invention, however, the effective cross-section of the nozzle opening and/or the clear diameter of the wide slot nozzle is not in a range of several millimeters, as is the case in the state of the art, but measures only 0.01 to 0.5 mm, preferably 0.02 to 0.2 mm.

The extremely low effective nozzle cross section in accordance with the invention—i.e., in the case of a wide slot nozzle a nearly hair-like nozzle slot—first leads drying medium to exit the nozzle slot in the form of a sharp, laminar ray at a very high exit speed. At the same time, the output volume flow is reduced sharply compared to the known dryer means due to the small available nozzle cross-section.

However, the maximum water vapor take-up capacity of the reduced volume flow, which is therefore theoretically also reduced, is more than compensated in that the narrow and sharp jet first of all generates significantly greater shear rates in the immediate boundary layer of the wet surface of the printing substrate, which is the deciding factor for the evaporation effect. In addition, the sharp gas jet, which enters the boundary layer at high speed, generates extremely intensive turbulence, which follow the immediate boundary layer. The special jet properties and the flow conditions obtained with said jet properties in the area of the surface of the printing substrate web finally have the effect that nearly the entire air quantity in the jet participates in the exchange of moisture between the web surface and the gas flow, which allows taking greater advantage of the thermodynamically possible maximum moisture take-up of the gas flow to a much greater extent than is the case with the known dryer means.

Because of the reduction of the volume flow, which is achieved by the highly effective substrate exchange in the area of the boundary layer of the printing substrate web, the drive performance of the print generation- and/or fan means, the heating performance required to heat the gas flow, as well as the cross-section of the supply line for the gas flow to the dryer means can also be reduced significantly, which in the end leads to significant cost savings in the purchase and operation of the system.

It is not important for the nature of the invention how the nozzle arrangement of the dryer means is supplied with the required gas flow. For example, blowers and/or pressure generators not designed for a high volume throughput, but for the generation of a relatively high excess pressure at a low volume flow, can be used advantageously for this purpose.

However, in an especially preferred embodiment of the invention, the nozzle arrangement is loaded with compressed gas and/or with compressed air. A load with compressed air is favorable to the initially described characteristics of the nozzle arrangement with especially fine nozzle outlet in that it is possible in this way to generate an air jet with a sufficiently large mass flow and with the desired high output speed even with an extremely small and/or hair-fine nozzle output.

The loading of an especially fine wide-slot nozzle with compressed air is also and in particular advantageous under the aspect of saving energy as well as under the aspect of optimally small line cross-sections because the smaller the air mass flow to be introduced into the printing machine and supplied to the nozzle arrangement, the smaller the required line cross-section as well as the mechanical performance required for the compression and for the additional heating of the drying air, if applicable.

With the use of compressed air, the line cross sections for the supply lines can be reduced even over-proportionally because on the one hand, a reduced mass flow is sufficient for a steady good drying result, while said mass flow can be transported through the supply lines with increased pressure and thus at increased density and thus at reduced flow speeds.

Especially favorable drying results were obtained in practice when the compressed air has a pressure of 1 to 5 bar, as is provided in accordance with a preferred embodiment of the invention, especially preferred of 2 to 4 bar, immediately before entering the nozzle arrangement.

In accordance with another preferred embodiment of the invention, the nozzle arrangement is arranged at an essentially elongated prismatic base nozzle body. From a construction point of view, a base nozzle body of this type, which is essentially rod-shaped, can be especially easily and flexibly accommodated within the small structural space available in the printing machine.

In that way, the base nozzle body and/or the nozzle arrangement in accordance with another preferred embodiment of the invention has an outer cross-section form that tapers cutting edge-like into the direction of the nozzle output. A cutting edge-like tapered outer cross-section of the wide slot nozzle, where the nozzle output slot therefore assumes the location of the imagined cutting edge, has the effect, especially in the operation of the nozzle with compressed air, that the air in the immediate vicinity of the nozzle is suctioned along the slanted outer flanks of the wide slot nozzle due to the high flow speed of the compressed air, which can be up to a plurality of 100 m/s at the nozzle output, and carried along by the jet to mix with the jet in intensive turbulence when it hits the surface of the printed substrate web.

Because of this effect, an even more reduced mass flow can be selected during steady optimum drying because a part of the ambient air is also utilized in the drying process in this way. In other words, in this way, it is possible to supply the dryer with an especially small quantity of especially highly compressed pressurized air, which leads to another reduction of the required line cross-sections.

Practical tests have shown that the volume flow for a typical machine configuration at a steady drying effect can be reduced from 3.53 m³/s according to the state of the art to 1.2 m³/s.

Furthermore, in this way, the heat generated in the compressor during the densification of the air can be fully utilized for the drying process because the machine- and flow parameters can be coordinated in such a way that the compressed air, which is still very hot at the nozzle output, mixes with the ambient air in such a way that the mixed air has an optimum temperature level in the range of about 100° C. when it hits the surface of the printing substrate web to be dried. Thus, the aforementioned machine configuration resulted in a reduction of the subsequent dryer performance from 220 kW to only 160 kW, which corresponds to an energy savings of 27%.

With this background, it is provided in accordance with a preferred embodiment of the invention that the nozzle arrangement is supplied directly by a compressor with compressed gas or compressed air. To be able to adjust the parameters such as air mass flow, pressure level, air temperature and the drying effect achieved therewith within especially broad limits and to the respectively required values, it is also possible, as provided by another embodiment of the invention, to arrange an auxiliary heating- or cooling system between the compressor and the nozzle arrangement. An auxiliary heating- or cooling system of this type, which can be developed as a heat exchanger that is integrated into the compressed air line, can adjust the temperature level of the compressed air and thus the mixed air that hits the surface to be dried, upward or downward, if required.

To obtain a quick, effective and steady drying across the entire width of the web, it is necessary to lead the drying medium and/or the compressed air blown onto the printing substrate web away again from the surface to be dried. Given this background, it is provided in accordance with another preferred embodiment of the invention that the drying medium and/or the compressed air is actively suctioned off again from the drying area after the moisture has been taken up. An especially preferred embodiment of the invention provides that the direction of suctioning the wet air from the surface to be dried runs essentially opposite to the direction in which it is blown on. In this way, it is possible to obtain an especially effective suctioning of the wet air with respect to flow technology, which furthermore saves space and is achieved evenly across the entire width of the printing substrate web. The reason for this is in particular that the suctioning in opposite direction to the blowing direction takes advantage of the kinetic rebound effect of the drying air, which hits the printing substrate web at high speed and leads to an especially effective and essentially laminar character of the suctioning flow.

In accordance with another preferred embodiment of the invention, it is provided that the nozzle arrangement and the nozzle base body are arranged in the area of the slotted opening of an elongated, prismatic nozzle box having a U- and/or C-shaped cross-section. In accordance with an especially preferred embodiment of the invention, the wet air can therefore be suctioned off through the slotted opening in the nozzle box by generating a negative pressure in the nozzle box opposite to the blow-on direction.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is an embodiment of a dryer in accordance with the present invention, in a schematic, block-diagram representation;

FIG. 2 the area of the nozzle arrangement of an embodiment of a drying means in lateral, partially sectioned representation;

FIG. 3 shows the area of the nozzle arrangement of the drying means according to FIG. 2 in top view; and

FIG. 4 shows the area of the nozzle arrangement of the drying means according to FIGS. 2 and 3 in cross-section.

### DESCRIPTION OF THE PREFERRED EMBODIMENT AND BEST MODE

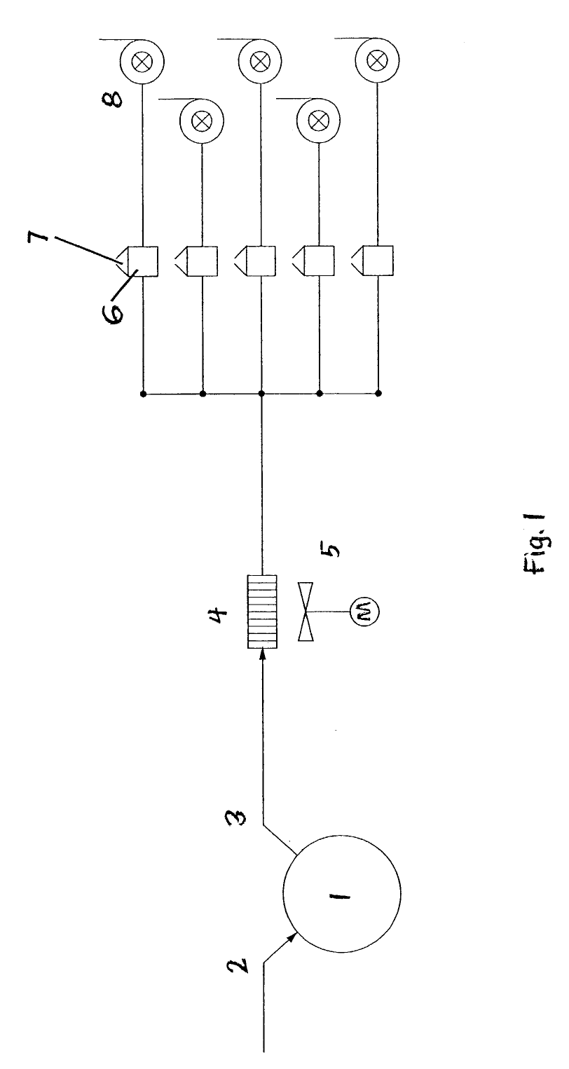

Referring now specifically to the drawings, a dryer according to the present invention is illustrated in FIG. 1 in schematic block diagram view. The structure of the dryer is that, for example, part of a printing machine to print corrugated board according to the flexography process. In that way, 1 describes the compressor that suctions the ambient air at 2, compresses said air and discharges the air in form of heated compressed at 3. The compressor 1 has a downstream heat exchanger 4 with a blower 5, which additionally heats the compressed air 3, if necessary, but can also cool it, if necessary. After the compressed air, which was brought to the target temperature, leaves the heat exchanger 4, it is then distributed to a number of presently five wide slot nozzles 6, which are indicated schematically, with one respective nozzle, for example, being assigned to one of the printing stations of a multi-color flexography machine.

The heated compressed air 5 flows through the narrow nozzle slot 7 of the (indicated) cutting edge-shaped wide slot nozzles 6 and carries along additional cooler ambient air and mixes with said air. The mixed air then hits the printing substrate web to be dried, which is led past the nozzle opening 7 of the wide slot nozzle 6 in a short distance (not shown in the diagram) and takes up the moisture from the fresh printing ink there, which caused the printing ink on the web to dry. The drying air, which is now laden with water vapor, rebounds from the printing substrate web due to the high flow speed and is respectively suctioned off by the ventilators 8 and supplied to the environment.

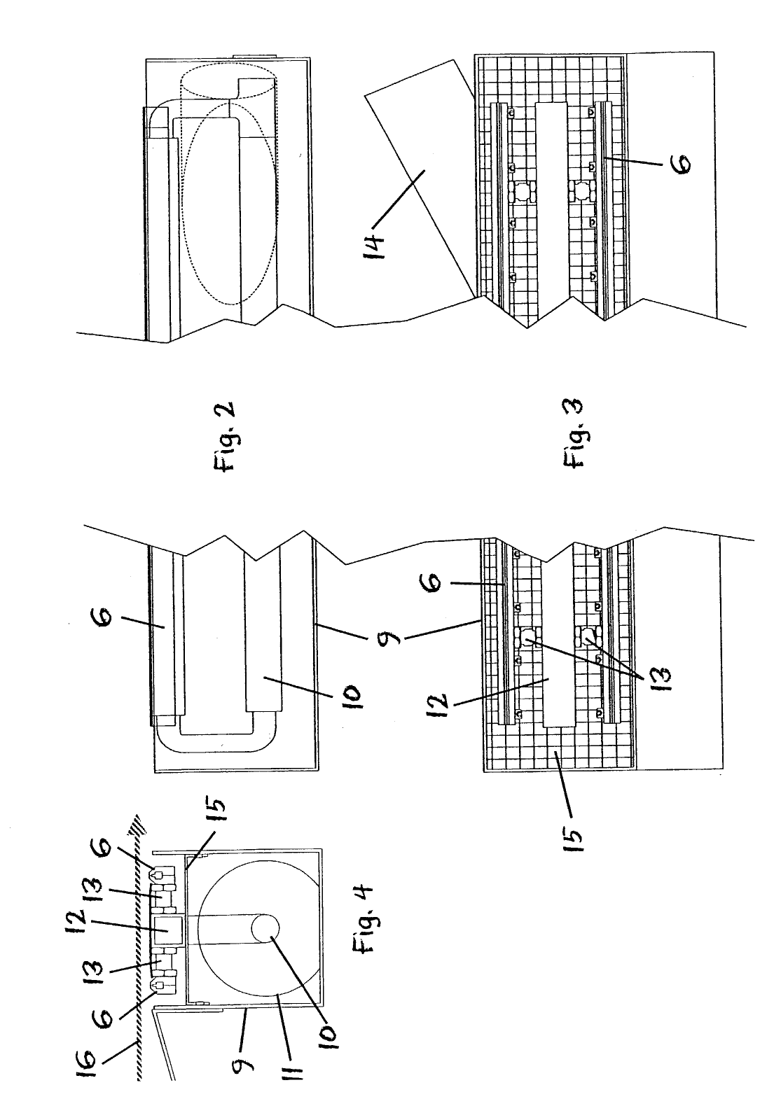

FIG. 2 shows the principal structure of the area of the nozzle arrangement of the dryer means. The arrangement of the wide slot nozzles 6 in an elongated nozzle box 9 in the upper area of the diagram is shown in particular in FIG. 2. Also shown is the supply line 10, which runs in the interior of the nozzle box 9 and supplies the hot compressed air to the nozzle slats 6.

FIG. 3 shows the nozzle box 9 with the wide slot nozzles 6 and the compressed air distribution line 12 arranged between the wide slot nozzles 6, from which the compressed air is introduced in steady distribution across the entire length of the wide slot nozzles 6 by means of a plurality of transfer nozzles 13 arranged steadily along the wide slot nozzles 6.

FIG. 3 furthermore shows a pipe connection 14, through which the interior of the nozzle box 9 can be loaded with negative pressure by a suction blower 8 (not shown FIG. 3). The grid-like structure 15 in the nozzle box 9 in FIG. 3 indicates that the compressed air distribution line 12, pipe nozzle 13 and wide slot nozzles 6 are arranged at the upper side of a perforated metal sheet 15 covering the nozzle box 9.

FIG. 4 shows the nozzle box 9 with the two wide slot nozzles 6 in accordance with FIGS. 2 and 3 in cross-section. The connection between the wide slot nozzles 6 and the compressed air distribution line 12 through the pipe nozzles 13 as well as the connection between the compressed air distribution line 12 and the compressed air supply line 10, which is guided in the center of the nozzle box 9 and has a thermal insulation 11. The angled sheet metal element that is arranged on the left side of the nozzle box 9 in the diagram is used in the known manner for the flawless throughput of the printing substrate web and/or the printing substrate sheets through the dryer.

FIG. 4 furthermore shows that the compressed air escaping from the nozzle slot of the wide slot nozzles 6 hits the printing substrate web 16 and then, because of the rebound effect related to the high flow speed and the negative pressure in the nozzle box 9, flows back and/or is suctioned back into the nozzle box and is suctioned off from there through the pipe nozzle 14 in accordance with FIG. 3.

FIG. 4 also shows that the nozzle strips 6 are comprised of two essentially symmetrical halves that in assembled condition form one respective hollow space for the supply of compressed air as well as the actual nozzle slot. Said two-part development of the nozzle strips 6 is especially significant in view of the fact that the fine nozzle slot can be produced in a simple, but extremely precise way.

The result shows that owing to the highly efficient material transfer, which is achieved in accordance with the invention the area of the boundary layer of the surface to be dried, a sustained, steady and efficient drying of the continuous, still wet printing substrate webs or sheets is achieved, with simultaneous and significant energy savings and a simplified construction of the printing machine.

A dryer is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A dryer adapted for use with a printing machine, and having at least one nozzle arrangement (6) with elongated, linearly effective nozzle output (7), especially wide slot nozzle arrangement, to blow a drying medium, especially air, onto a surface (16) to be dried, characterized in that the nozzle arrangement (6) has an effective nozzle opening width of 0.01 mm to 0.5 mm.

2. The dryer in accordance with claim 1, characterized in that the nozzle arrangement (6) is adapted for being loaded with compressed gas and/or compressed air.

3. The dryer in accordance with claim 1 or 2, characterized in that the compressed air has a pressure of 1 bar to 5 bar immediately before entering into the nozzle arrangement (6).

4. The dryer in accordance with claim 1, characterized in that the nozzle arrangement (6) is arranged at an essentially elongated prismatic nozzle base body.

5. The dryer in accordance with claim 4, characterized in that one or the other of the nozzle base body and the nozzle arrangement (6) have an outer cross-section that tapers cutting edge-like into the direction of the nozzle outlet (7).

6. The dryer in accordance with claim 2, characterized in that the nozzle arrangement (6) is supplied with compressed directly through a compressor (1).

7. The dryer in accordance with claim 1, characterized in that one or the other of an auxiliary heating- and cooling system (4, 5) is arranged between the compressor (1) and the nozzle arrangement (6).

8. The dryer in accordance with claim 1, characterized in that the drying medium is adapted to be suctioned off again from the drying area immediately after taking up moisture from the surface to be dried (16).

9. The dryer in accordance with claim 8, characterized in that the direction of suction runs essentially opposite to the blow-on direction.

10. The dryer in accordance with claim 1, characterized in that the nozzle arrangement (6) is arranged in the area of the opening of an essentially elongated, prismatic nozzle box (9) that is essentially U- or C-shaped in cross-section.

11. The dryer in accordance with claim 8, characterized in that the suctioning takes place through the slotted opening of the nozzle box (9) by means of generating a negative pressure in the nozzle box (9).
